(19) United States
(12) Patent Application Publication
(10) Pub. No.: US 2023/0102581 A1
(43) Pub. Date: Mar. 30, 2023

(54) ENTERPRISE MANAGEMENT SYSTEM

(71) Applicant: Vinh Vo, Bethesda, MD (US)

(72) Inventor: Vinh Vo, Bethesda, MD (US)

(21) Appl. No.: 17/732,159

(22) Filed: Apr. 28, 2022

Related U.S. Application Data
(60) Provisional application No. 63/248,073, filed on Sep. 24, 2021.

(51) Int. Cl. G06Q 10/10

(52) U.S. Cl. CPC G06Q 10/1097

(57) ABSTRACT

Disclose is a system and method for enterprise management that allow organizations to handle and manage their operations efficiently and productively. A single interface can be used to access different services and can retrieve data from different departments for analysis and reporting. The budget planning feature allows any department to track, split the cost, and manage their spending. Multiple members or departments in an organization can collaborate and upload their files using the disclosed system and method. The connector module can allow the connecting to different third-party applications through a single interface. Moreover, a calendar interface can present tasks for approval and status of transactions day-wise, month-wise, and year-wise.

### CROSS-REFERENCE TO RELATED APPLICATIONS

This application claims priority to the U.S. provisional patent application Ser. No. 63/248,073, filed on Sep. 24, 2021, which is incorporated herein by reference in its entirety.

### FIELD OF INVENTION

The present relates to a system and method for enterprise management, and more particularly, the present invention relates to a unified platform for managing different departments in an organization.

### BACKGROUND

In a business organization, there can be different departments each performing a set of operations, such as accounts, Human resources, sales, manufacturing, and like. Handing different operations require skilled professionals. However, in small or medium enterprises, the team size is limited, and a single person may have to handle multiple tasks. In small organizations, a single person may have to handle most of the tasks on his own.

Software are available for different tasks that make the process easier, such as CRM software are available to handle sales and customer relations, accounting software manages invoices, payments, and records, similarly, team management software are also available that makes the process of assigning and tracking projects easier and also includes reminders. However, the use of multiple software can be difficult, tedious, and often costly. So people may rely on spreadsheet programs for most of their tasks. However, the use of spreadsheets or using nonrelated multiple software can often be unproductive. Also, the persons track their budget and planning through spreadsheets. It is difficult if not possible, to categorize spending by department and spending types. Data are unorganized and locked up between different systems, and it takes time to log in to each system to get the data to create a simple-to-read report.

A need is therefore appreciated for a cloud-based enterprises management software that can handle most tasks in an organization efficiently and productively.

Hereinafter, the terms enterprise, business, and organization are interchangeably used and broadly refer to persons including firms and companies providing goods and/or services for profit or charity.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for managing different operations in enterprises.

It is another object of the present invention that the different operations can be accessed through a single interface.

It is still another object of the present invention that the data from different departments can be easily shared and analyzed.

It is yet another object of the present invention that certain tasks can be automated.

It is a further object of the present invention that reports in graphical formats can be presented to summarize different operations.

A one aspect, disclosed is a method for enterprise management, the method implemented within a system comprising a processor and a memory, the method comprises the steps of providing a connector module, wherein the connector module is configured to connect with a plurality of third-party applications, wherein the plurality of third-party applications is not hosted on the system; providing a common interface configured to provide access to the plurality of third-party applications; receiving, a plurality of tasks from multiple platforms and the connector module; providing a calendar interface, wherein the plurality of tasks are presented on the calendar interface; and receiving approval of one or more tasks of the plurality of tasks through the calendar interface. Presenting statuses of the plurality of tasks through the calendar interface. The statuses of the plurality of tasks comprises timelines for the plurality of tasks. The statuses of the plurality of tasks are presented day-wise, months-wise, and year-wise. The method further comprises the steps of tracking, through a planning module, distribution and spending of budget.

In one aspect, disclosed is a system for enterprise management, the system comprising a processor and a memory, the system configured to implement a method comprising the steps of providing a connector module, wherein the connector module is configured to connect with a plurality of third-party applications, wherein the plurality of third-party applications is not hosted on the system; providing a common interface configured to provide access to the plurality of third-party applications; receiving, a plurality of tasks from multiple platforms and the connector module; providing a calendar interface, wherein the plurality of tasks are presented on the calendar interface; and receiving approval of one or more tasks of the plurality of tasks through the calendar interface.

### BRIEF DESCRIPTION OF THE DRAWINGS

FIG. 1 is a block diagram illustrating the environment of the system, according to an exemplary embodiment of the present invention.

FIG. 2 is another block diagram showing the architecture of the system, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclose is a system and method for enterprise management. The disclosed system and method may allow organizations to handle and manage their different operations efficiently and productively. A single interface can be used to access different services and can retrieve data from different departments for analysis and reporting. Using the agile budget planning feature of the disclosed system and method, any department can easily track, split the cost, and manage their spending using a simple-to-use interface provided by the disclosed system and method. In addition, multiple members or departments in an organization can collaborate and upload their files using the disclosed system and method. Steps of approval of transactions at various stages can be easily set up and allow tracking and reporting easier without wasting time. Consumption of budged by different departments can be graphically presented and suitable timely actions can be taken. Combinations of design elements, graphs, and colors can be used in the interface to present information in the analysis in a comprehensive way. For example, when a budget of a particular department is above certain limits, a notification can be displayed, and the approval process can kick in.

Customer relationship management and campaigns are an essential part of any sales department. The disclosed system can provide a suitable CRM platform or allow integration with a commercially available CRM platform. For example, CRM as stand-alone packages and cloud-based software as service (SaaS) are available commercially. The disclosed system can use any such platform for creating campaigns. Integration of CRM with calendars and accounts can automate certain tasks, such as the scheduled campaigns can automatically appear in a calendar of the disclosed system. Similarly, tasks from the accounts department can be pulled into the calendar, and the data between different departments can be shared to automate certain tasks. The calendar interface can also pull in additional 3rd party data sources, so the users between departments can see activities happening within a campaign. For example, the customer data from CRM and related projects data from the operation department can be automatically shared with the accounts department to process invoices. All the timelines from different departments can be pulled into the calendar interface for various purposes such as tracking, approvals, and the like. The disclosed system and method can also connect to third-party service providers and can pull data from third-party service providers for analysis and campaigns. The data can be used to create graphing elements for a holistic view starting from budgeting and planning down to their campaign's performance.

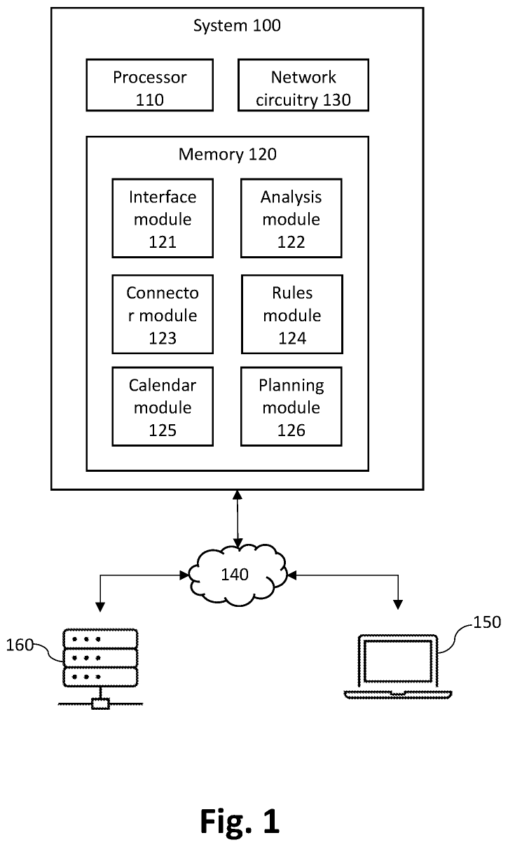

Referring to FIG. 1 which is a block diagram showing the disclosed system 100 having a processor 110 and a memory 120. The processor 110 can be any logic circuitry that responds to and processes instructions fetched from the memory 120. The memory 120 may include one or more memory chips capable of storing data and allowing any storage location to be directly accessed by the processor. The memory 120 includes modules according to the present invention for execution by the processor to perform one or more steps of the disclosed methodology for enterprises management. A network circuitry 130 can allow the disclosed system 100 to connect to an external network 140. The network 140 may be a wired network, a wireless network, or may include a combination of wired and wireless networks. For example, the network 140 may be a local area network (LAN), a wide area network (WAN), a wireless WAN, a wireless LAN (WLAN), a metropolitan area network (MAN), a wireless MAN network, a cellular data network, a cellular voice network, the Internet, etc. In some aspects, the network 140 may couple to the system 100 using one or more communication protocols such as TCP/IP. Network 140 can be a cellular network including 2 G, 3 G, 4 G, 5 G, LTE, CDMA, and the like. Network 140 can be a secured or unsecured network. The disclosed system can be implemented in an environment of one or more servers which includes cloud servers. One or more servers can be dispersed in an individual location or multiple locations without departing from the scope of the present invention. The disclosed system can connect to user devices 150 through a network. For example, the disclosed system 100 can be hosted in a cloud environment, and user devices 150 can connect to the disclosed system 100 through a network 140. The disclosed system 100 can also connect to the third-party service provider 160 through the network 140. While FIG. 1 shows a single network 140 for illustration only, it is understood that two devices can connect through different networks and one device can connect through a combination of two or more networks without departing from the scope of the present invention.

Memory 120 can include modules such as an interface module 121, analysis module 122, connector module 123, rules module 124, calendar module 125, and a planning module 126. The module herein refers to a set of instructions, code, software, and the like which when executed by the processor causes the processor to perform one or more steps of the disclosed methodology. The interface module can provide an interface on a user device for interacting with the disclosed system. The interface can allow a user to upload and download data between the user device and the system. The interface may allow departments in an organization to collaborate and share data. The interface may also allow operating various third-party services, such as Salesforce™, Trello™, Marketo™, Zoom™, and Google Analytics™. Through the disclosed interface, the different services can be tracked and accessed from a single screen making the work easier and more productive.

The interface can be provided as application software that can be installed on the user device 150. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux™, and macOS™. The user interface may permit interacting with a user through the user device, wherein information can be presented within the user interface by the system 100 and information can be received by the system 100 from the user.

The analysis module can pick data from different departments including timelines and analyze the data for automation, reports, and the like. The analysis module through the interface allows the users of the system to view near real-time status of different departments, projects, workloads, and the like. The analysis module can provide requested data for use by the different departments. The analysis module can present a graphical report showing the status of different departments and progress.

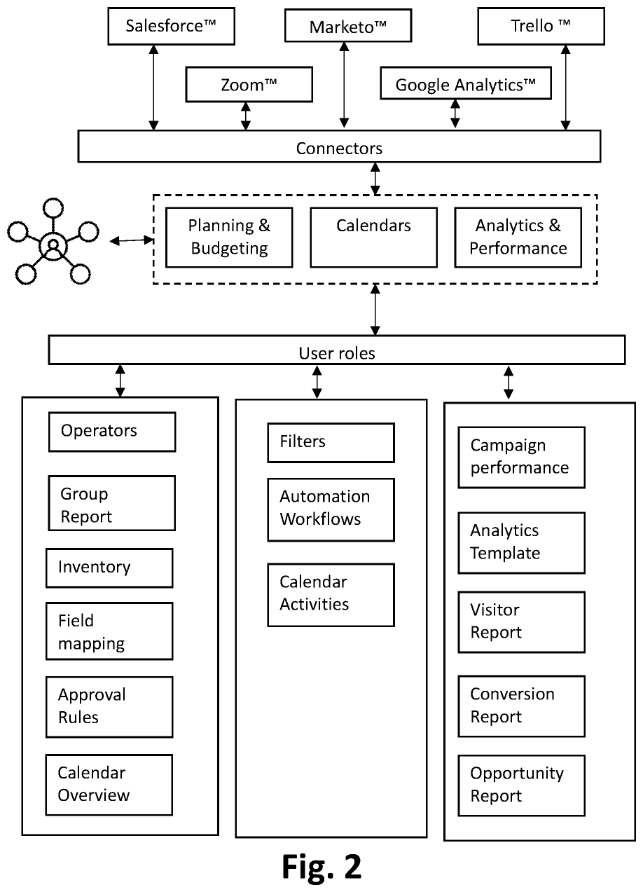

The connector module upon execution by the processor can allow connecting third-party applications and services to the connected and accessed through the disclosed system. Referring to FIG. 2 which shows the disclosed connector that can connect diverse services not hosted by the disclosed system. Such services can be accessed through an interface generated by the interface module. The connector module can allow connecting various third-party services, pulling data from the external databases and third-party service providers, and pushing data to the external databases and the third-party service providers. FIG. 2 only shows a few examples of the third-party service providers; however, more service providers can be added or the existing service providers can be removed without departing from the scope of the present invention. The disclosed system can automate the task of sharing data between different service providers. For example, the contact details from CRM can be imported into zoom for a video conference.

The rules module can make the disclosed system versatile by allowing the user to customize the disclosed system according to their needs or the needs of the organization. Various rules can be set to define the sharing of data between departments and between the system and the third-party service providers. Automation tasks can be programmed using the disclosed rules module. Filters can be defined for processing the data and preparing reports. Templates for reports can be customized and defined by the rules module. The different rules can be programmed using a programming language that is easy to use and understand. Rules can be defined to set the authorization scheme and levels for different users and how approvals are made between departments.

The calendar module can interact with the different modules and third-party service providers for obtaining timelines and details of tasks. The calendar module through a calendar interface can show the timelines and tasks on a single screen arranged day-wise, months-wise, and year-wise. The calendar interface can also provide action buttons coupled with the tasks through which the said action can be triggered, or a new interface can be opened directly through the calendar interface. For example, the calendar interface can show the task of sending an invoice on the 25th. The user can view the task on the calendar interface, the task on the calendar interface can be made actionable, wherein the user can click the task. Clicking the task can perform an action that can be defined using the rules module. For example, the invoice can be automatically created and presented for editing and approval by the user.

The planning module can be used to plan budgets and activities of different departments. The planning module through an interface provided by the interface module can show the budgeted amount and spending of each department. The details can be presented graphically through the interface.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for enterprise management, the method implemented within a system comprising a processor and a memory, the method comprises the steps of:
providing a connector module, wherein the connector module is configured to connect with a plurality of third-party applications, wherein the plurality of third-party applications is not hosted on the system;
providing a common interface configured to provide access to the plurality of third-party applications;
receiving, a plurality of tasks from multiple platforms and the connector module;
providing a calendar interface, wherein the plurality of tasks are presented on the calendar interface; and
receiving approval of one or more tasks of the plurality of tasks through the calendar interface.

2. The method according to claim 1, wherein the method further comprises the steps of:
presenting statuses of the plurality of tasks through the calendar interface.

3. The method according to claim 2, wherein the statuses of the plurality of tasks comprises timelines for the plurality of tasks.

4. The method according to claim 3, wherein the statuses of the plurality of tasks are presented day-wise, months-wise, and year-wise.

5. The method according to claim 1, wherein the method further comprises the steps of:
tracking, through a planning module, distribution and spending of budget.

6. A system for enterprise management, the system comprising a processor and a memory, the system configured to implement a method comprising the steps of:
providing a connector module, wherein the connector module is configured to connect with a plurality of third-party applications, wherein the plurality of third-party applications is not hosted on the system;
providing a common interface configured to provide access to the plurality of third-party applications;
receiving, a plurality of tasks from multiple platforms and the connector module;
providing a calendar interface, wherein the plurality of tasks are presented on the calendar interface; and
receiving approval of one or more tasks of the plurality of tasks through the calendar interface.

7. The system according to claim 6, wherein the system is further configured to implement the steps of:
presenting statuses of the plurality of tasks through the calendar interface.

8. The system according to claim 7, wherein the statuses of the plurality of tasks comprises timelines for the plurality of tasks.

9. The system according to claim 8, wherein the statuses of the plurality of tasks are presented day-wise, months-wise, and year-wise.

10. The system according to claim 6, wherein system is further configured to implement the steps of:
tracking, through a planning module, distribution and spending of budget.
